(19) United States
(12) Patent Application Publication
(10) Pub. No.: US 2026/0289539 A1
(43) Pub. Date: Sep. 24, 2026

(54) DEPLOYING ROBOT CARTS IN RETAIL ENVIRONMENTS

(71) Applicant: Dell Products L.P., Round Rock, TX (US)

(72) Inventors: Michael Robillard, Shrewsbury, MA (US); Rushiv Arora, Boston, MA (US); Ramona Devi, San Jose, CA (US); Robert Lee, Marlborough, MA (US); Yichun Xu, Everett, MA (US); Xuebin He, Westwood, MA (US)

(21) Appl. No.: 19/087,936

(22) Filed: Mar. 24, 2025

(51) Int. Cl. G06Q 20/20; G06Q 10/047

(52) U.S. Cl. CPC G06Q 20/203; G06Q 10/047; G06Q 20/206

(57) ABSTRACT

A robot cart may receive input that identifies a user who will use the autonomous robot cart to hold one or more items that the user has selected. A robot cart may manage in real-time an inventory of the one or more items that the user has selected. A robot cart may provide a running total of a cost of the one or more items that the user has selected. A robot cart may move the one or more items that the user has selected to a check-out location of a retail location so that the user is able to purchase the one or more items.

### TECHNOLOGICAL FIELD OF THE DISCLOSURE

Embodiments disclosed herein generally relate to infrastructure in retail environments. More particularly, at least some embodiments relate to systems, hardware, software, computer-readable media, and methods for optimizations for deploying robot carts in retail environments.

### BACKGROUND

The accelerating pace of digital transformation in retail is catalysed by immersive technologies that facilitate complex interactions between humans and AI-driven systems. In contemporary retail, the need to provide ways that add convenience to the shopping experience can be useful in distinguishing one retail location from another retail location.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a retail location where embodiments disclosed herein may be practiced.

FIG. 2 discloses aspects of a robot cart according to the embodiments disclosed herein.

FIGS. 3A-3C disclose aspects of operating a robot cart in a retail location according to the embodiments disclosed herein.

FIG. 4 discloses aspects of a method according to the embodiments disclosed herein.

FIG. 5 discloses a computing entity configured and operable to perform any of the disclosed methods, processes, and operations.

### DETAILED DESCRIPTION OF SOME EXAMPLE EMBODIMENTS

Embodiments disclosed herein generally relate to infrastructure in retail environments. More particularly, at least some embodiments relate to systems, hardware, software, computer-readable media, and methods for optimizations for deploying robot carts in retail environments.

In some aspects, the techniques described herein relate to an autonomous robot cart including: one or more processors; and one or more non-transitory computer-readable hardware storage devices having stored thereon computer-executable instructions that are structured such that, when executed by the one or more processors, the computer-executable instructions causing the autonomous robot cart to perform at least: receive input that identifies a user who will use the autonomous robot cart to hold one or more items that the user has selected; manage in real-time an inventory of the one or more items that the user has selected; provide a running total of a cost of the one or more items that the user has selected; and move the one or more items that the user has selected to a check-out location of a retail location so that the user is able to purchase the one or more items.

In some aspects, the techniques described herein relate to a method for operating an autonomous robot cart in a retail location, the method including: receiving input that identifies a user who will use the autonomous robot cart to hold one or more items that the user has selected; managing in real-time an inventory of the one or more items that the user has selected; providing a running total of a cost of the one or more items that the user has selected; and moving the one or more items that the user has selected to a check-out location of a retail location so that the user is able to purchase the one or more items.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

Accordingly, at least some of the embodiments disclosed herein provide for the incorporation of a robot carts equipped with an AI-driven user interface. This robot carts serves the dual purpose of inventory management and offering customer support. By harnessing artificial intelligence, the robot cart streamlines the inventory management process and provides valuable assistance to customers.

At least some of the embodiments disclosed herein provide an autonomous robot cart that tracks and accompanies customers throughout the retail location. This robot cart is designed to enhance the shopping experience by autonomously following the customer, ensuring convenience and ease of navigation within the store.

At least some of the embodiments disclosed herein provide individual robot carts assigned to each retail location aisle. When a customer selects an item and places it in their robot cart, the robot cart in their respective aisle collects the item and delivers it to a designated storage location at the checkout area. This not only streamlines the shopping process but also expedites the checkout, potentially eliminating the need to wait in line. The fusion of this automated robot cart system with checkout lines offers a comprehensive solution for optimizing the retail shopping experience.

At least some of the embodiments disclosed herein provide an autonomous robot cart that is able to detect and recognize hand gestures that direct the movement of the robot cart. This provides a way to redirect the robot cart from its intended route when circumstances warrant, thus ensuring safe operation of the robot cart.

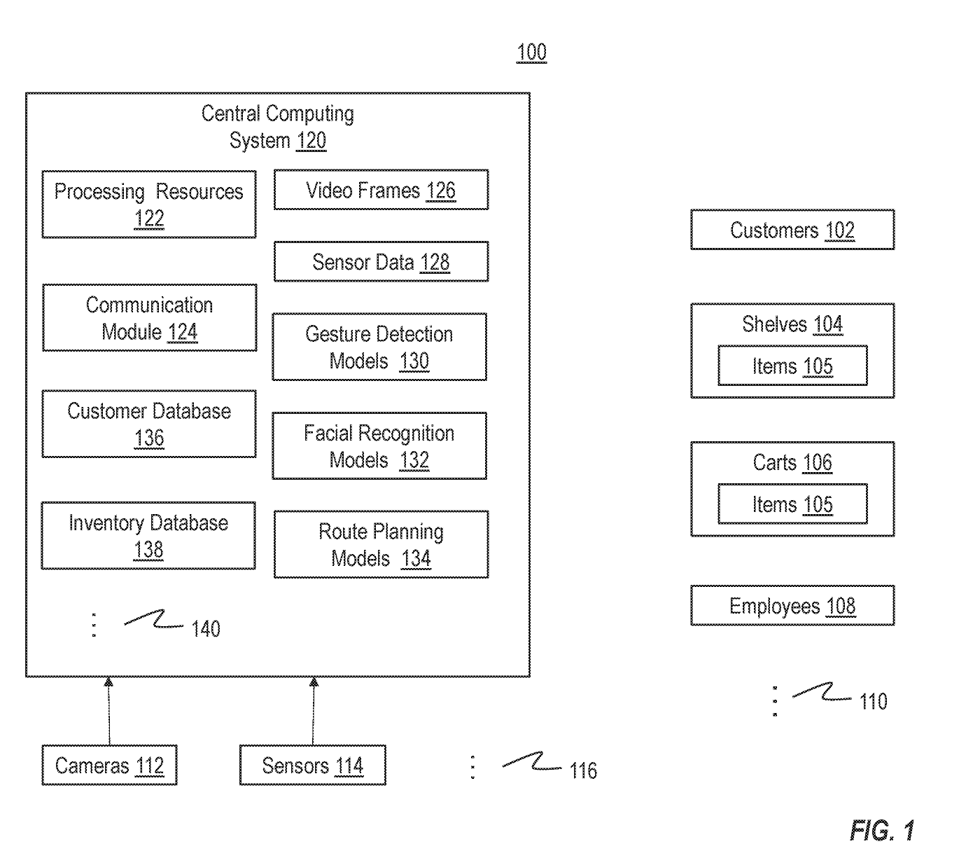

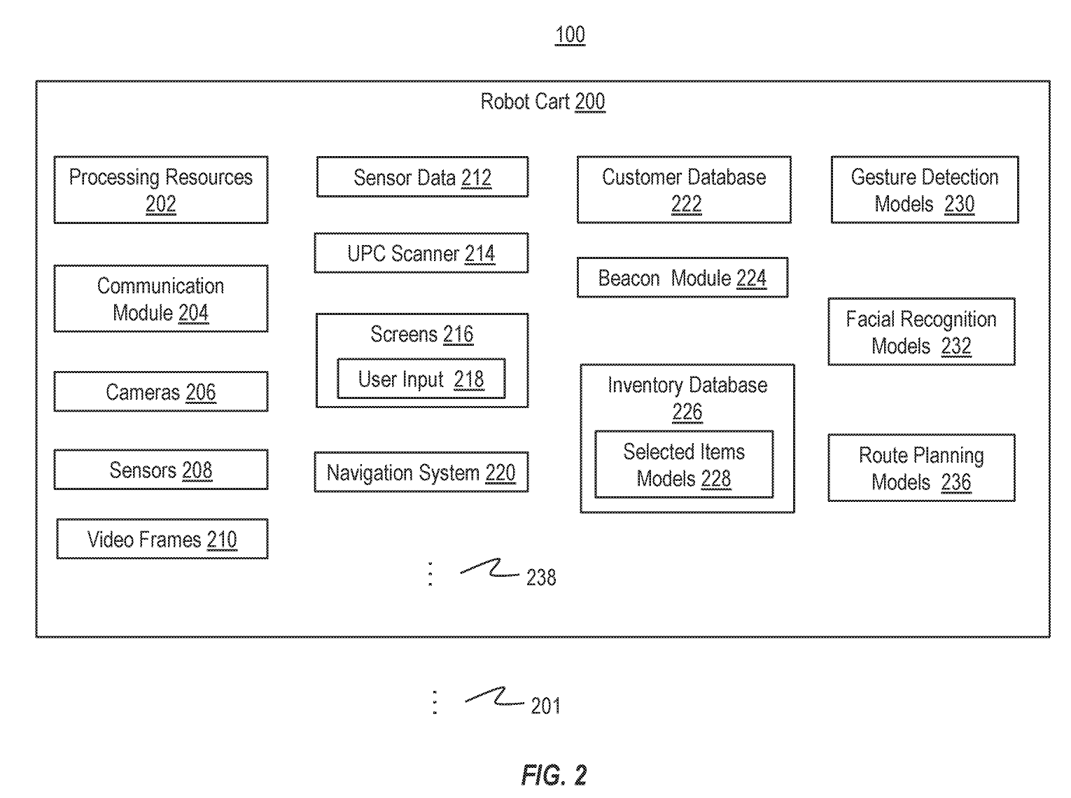

FIG. 1 illustrates an embodiment of a retail location 100, such as a grocery store or department store, although the embodiments disclosed herein are not limited to any particular type of retail location. As illustrated, one or more customers 102 access the retail location 100 to shop for items 105 provided by the retail location 100. During their shopping experience, the customers 102 can access shelves 104 that are located in the retail location 100 to pick the items 105 from the shelves 104 that they desire to purchase. In some embodiments, especially if the retail location 100 is a grocery store or the like, the customers 102 can use one or more shopping carts 106 to place the desired items 105 they have taken from the shelves 104 until such time as they purchase the items. As will be described in more detail in relation to FIG. 2, the carts 106 can be implemented as a robot cart 200.

The retail location 100 also includes one or more employees 108 who work at the retail location to provide services to the customers 102. For example, the employees 108 can be checkers who receive payment from the customers for purchase of the items 105, security staff, or custodial staff who clean the retail location 100. The ellipses 110 represent that there can be additional people in the location 100 such as suppliers who provide the items 105.

The retail location 100 includes one or cameras 112 and one or more sensors 114. There can also be any number of additional cameras and/or sensors 116 that are placed in the retail location 100 as represented by the ellipses. In operation, the cameras 112 and the one or more sensors 116, and potentially the additional cameras and sensors 114 monitor various different rooms of the retail location 100 such a main room where the customers 102 shop as well as any storerooms, break rooms, and the like that are frequented by the employees 108, and monitor the customers 102, the shelves 104, the shopping carts 106, and the employees 108.

In some embodiments, the cameras 112 can be a depth camera. A depth camera is a specialized camera that measures the distance between itself and objects in a scene, essentially providing a 3D perspective by assigning a "depth" value to each pixel in an image, allowing it to not only capture what an object looks like but also how far away it is from the camera; this information is often represented as a depth map where different colors or values correspond to different distance. Of course, one or more of the cameras 112 can be other types of cameras as well. In some embodiments, the one or more sensors 114 can be motion sensors that detect the actions of the customers 102, the carts 106, and/or the employees 108 such as motion sensors, fall detection sensors, gravity sensors, or the like.

The retail location 100 also includes a central computing system 120. The central computing system 120 can be comprised of a computing system that is local to the retail location 100 or it can be a distributed computing system that has components that reside in the cloud or that are not located at the retail location 100.

In at least some embodiments, the central computing system 120 can be considered as a central node of a computing system that includes one or more robot carts 200 as edge nodes as will be explained in more detail to follow. Accordingly, the central computing system 120 includes processing resources 122, which in some embodiments can be a NVIDIA jetson, although the embodiments disclosed herein are not limited to any particular type of processing resource. The processing resources 122 run various operational modules, databases, and/or machine-learning (ML) or Artificial Intelligence (AI) models of the central computing system. The central computing system 120 also include a communication module 124, which can include any reasonable hardware that allows the central computing system to communicate with the robot carts 200.

In operation, the central computing system 120 receives video frames 126 from the cameras 112 and sensor data 128 from the one or more sensors 114. The video frames 126 and the sensor data 128 can then be used by one or more ML or AI models that are included in the central computing system 120 to provide useful information to a customer 102, an employee 108, or to the owner of the retail location 100 based on the video frames 126 and/or the sensor data 128. The one or more ML or AI models can also be used by one or more of the robot carts 200 as will be explained in more detail to follow.

For example, the central computing system 120 can include gesture detection models 130 that recognize hand gestures from customers 102 and employees 108, facial recognition models 132 that recognize facial expressions to identify and distinguish a given customer 102 or employee 108 from other customers and employees, and route planning models 134 that are used to plan routes for the robot carts 200 given the overall structure of the retail location 100 and the location of the shelves 104 and the like inside the structure.

The central computing system 120 includes a customer database 136. The customer database includes information about the customers 102, such as their spending habits at the retail location 100 and also includes identification information about the customers that does not include personal or sensitive information. In some embodiments, in order to preserve customer privacy, the customers 102 choose the information that is used to identify them and then upload that information to the customer database 136, such as a picture of themselves or pin number. In the case of uploading a picture, the picture can be used to help the facial recognition models in their operation.

The central computing system 120 also includes an inventory database 138. The inventory database 138 stores data about the inventory of the items 105 that are on the shelves 104 and held in a storage area. This information can be updated in real time and, as will be explained in more detail to follow, the robot carts 200 can help to update the inventory database 138. The ellipses 140 represent that the central computing system 120 can include additional operational modules, databases, and/or ML models as circumstances warrant.

FIG. 2 illustrates an embodiment of a robot cart 200 that operates in the retail location 100 and corresponds to one of the carts 106. The ellipses 201 represent that there may be any number of additional robot carts operating in the retail location 100. Accordingly, the description of the robot cart 200 applies to the additional robot carts represented by the ellipses 201.

As illustrated, the robot cart 200 includes processing resources 202, which in some embodiments can be a NVIDIA jetson, although the embodiments disclosed herein are not limited to any particular type of processing resource. The processing resources 202 run various operational modules, databases, and/or machine-learning (ML) or Artificial Intelligence (AI) models of the robot cart 200. Thus, the robot cart 200 generally does not need to rely on the processing resources 122 of the central computing system 120 as the robot cart has its own processing resources.

However, in some instances the processing resources 202 may not be sufficient to run all the operational modules, databases, and/or ML or AI models of the robot cart 200. In such instances, the robot cart 200 can offload some of the processing workload to the processing resources 122 or to the processing resources of one of the additional robot carts represented by the ellipses 201. Thus, the robot cart 200 only relies on the processing resources of central computing system 120 when its own processing resources are not sufficient. This leads to optimized processing in the retail location 100 by pushing most of the computation workload to the robot carts acting as edge devices.

The robot cart 200 also includes a communication module 204. The communication module 204 includes all the hardware and software needed for the robot cart 200 to communicate with the central computing system 120, the additional robot carts represented by the ellipses 201, customers 102, and employees 108.

The robot cart 200 includes one or cameras 206 and one or more sensors 208. The cameras 206 can be depth cameras and the sensors 208 can corresponds to the sensors 114 previously described. In operation, the cameras 206 generate video frames 210 and the sensors 208 generate sensor data 212. The video frames 210 and the sensor data 212 are used by various ML or AI models of the robot cart 200 as will be described in more detail to follow.

The robot cart 200 includes a UPC scanner 214. In operation, a customer 102 is able to scan an item 105 using the UPC scanner 214. This results in information such as price to be displayed on one or more screens 216. In addition, the price of the items 105 that the customer 102 is buying can be added to a running total to be used at check-out time.

The robot cart 200 includes the one or more screens 216. The screens 216 allow for the customer 102 to interact with the robot cart 200. For example, a user input 218 that can be a touch pad on one of the screens or another user input device such as a keyboard allows the customer 102 to input information into the computing system of the robot cart 200. In addition, the customer is able to view information about the retail location 100, the items 105, or receive other messages from the owners of the retail location 100 such as coupons or special offers that can be shown on the screens. The implementation of more than one screen allows for multiple views for the customer 102. For example, a first screen can include the user input touch pad, a second screen can show a map of the retail location 100, location of different items 105, and other information about the items 105, and a third screen can show messages and special offers for the customer 102. In some embodiments, a single computing device, which can be the processing resources 202, is able to stream information across all of the screens 216 by using a daisy chain of display ports on the screens 216.

The robot cart 200 includes a navigation system 220. The navigation system 220 includes all the hardware and software needed for the robot cart 200 to autonomously move around the retail location 100. The navigation system 220 also includes a map of the retail location 100 that can be displayed on one of the screens 216.

In one embodiment, the navigation system 220 works with route planning models 236 to determine an optimum route for the robot cart to follow based on the collected video frames 210 and sensor data 212 and input received from the customers 102 about what items 105 they wish to purchase. In some embodiments, the route planning models 236 works in conjunction with the route planning models 134.

The robot cart 200 includes a customer database 222. The customer database 222 includes information about the customers 102, such as their spending habits at the retail location 100 and also includes identification information about the customers that does not include personal or sensitive information. In some embodiments, in order to preserve customer privacy, the customers 102 choose the information that is used to identify them and then upload that information to the customer database 222, such as a picture of themselves or pin number.

In the case of uploading a picture, the picture can be used by facial recognition models 232 in their operation. For example, the facial recognition models 232 can recognize facial expressions collected in the video frames 210 to identify and distinguish a given customer 102 or employee 108 from other customers and employees. The robot cart 200 can then use this visual recognition to be assigned to a given customer 102 or employee 108 as will be explained in more detail.

In some embodiments, the robot cart 200 includes a beacon module 224. In such embodiments, each customer 102 or employee 108 is assigned a beacon. The beacon module 224 then allows the robot cart 200 to distinguish each customer 102 and employee 108 based on the beacon signals. Thus, the use of the beacons is another way to assign a robot cart to a given customer 102 or employee 108.

The robot cart 200 also includes an inventory database 226, which in some embodiments works in conjunction with the inventory database 138. The inventory database 226 stores data about the inventory of the items 105 that are on the shelves 104 or are held in a storage area of the retail location 100. In one embodiment, the inventory database 226 includes selected items models 228. The selected items models 228 deduct the number of items 105 placed in the robot cart 200 from the original inventory number to calculate a current inventory number for each item 105. If the current inventory number for a given item 105 goes below a pre-defined threshold, the selected items models 228 can issue a low-inventory message to an employee 108 that notifies the employee that the given item 105 needs to be restocked on the shelves 104.

The robot cart 200 also includes gesture detection models 230 that detect and recognize hand gestures collected in the video frames 210 from customers 102 and employees 108 that are related to the movement of the robot carts 200. For example, a palm means stop here, pointing to the right means to make it go to the right, pointing to the left means to make it go to the left, etc. Thus, if robot cart needs to deviate from the path designated by the route planning models 236 because of an unforeseen event, such as an item 105 spilling in an aisle or for a medical emergency, a customer 102 or an employee 108 can use the hand gestures and the gesture detection models 230 will cause the robot cart to follow the directions of the gestures. The ellipses 238 represent that the robot cart 200 can include additional operational modules, databases, and/or ML models as circumstances warrant.

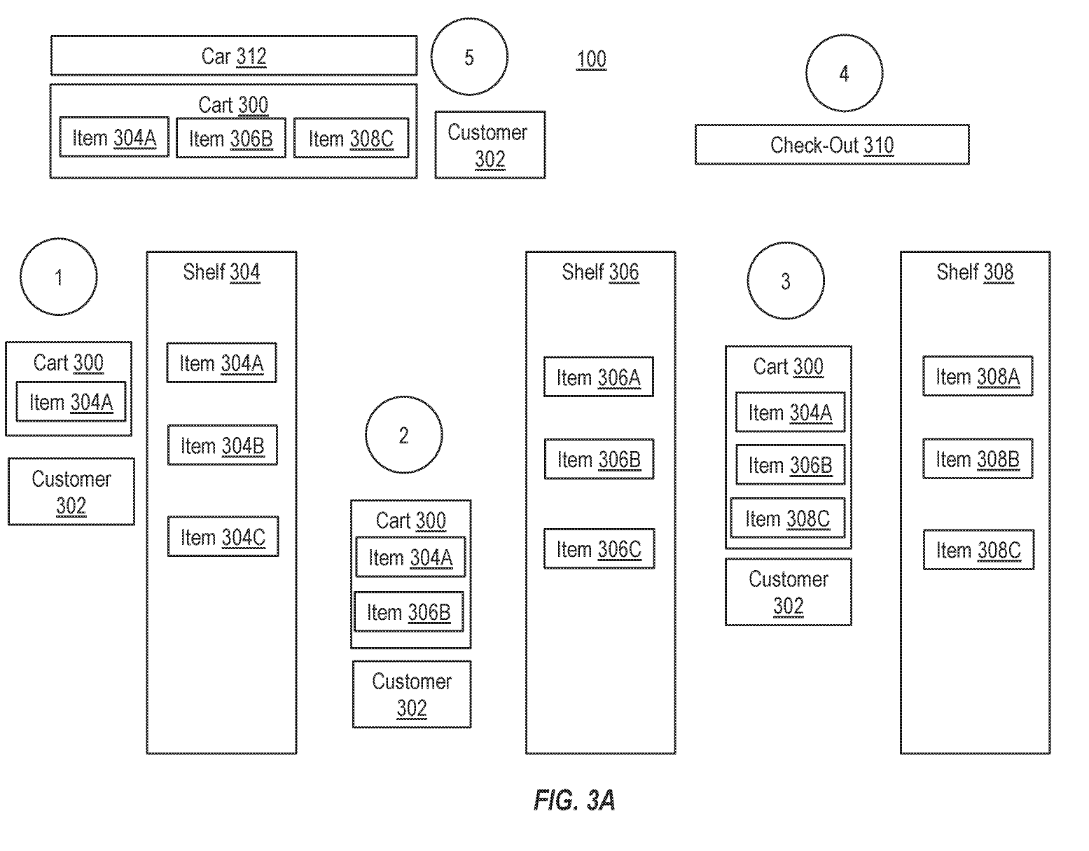

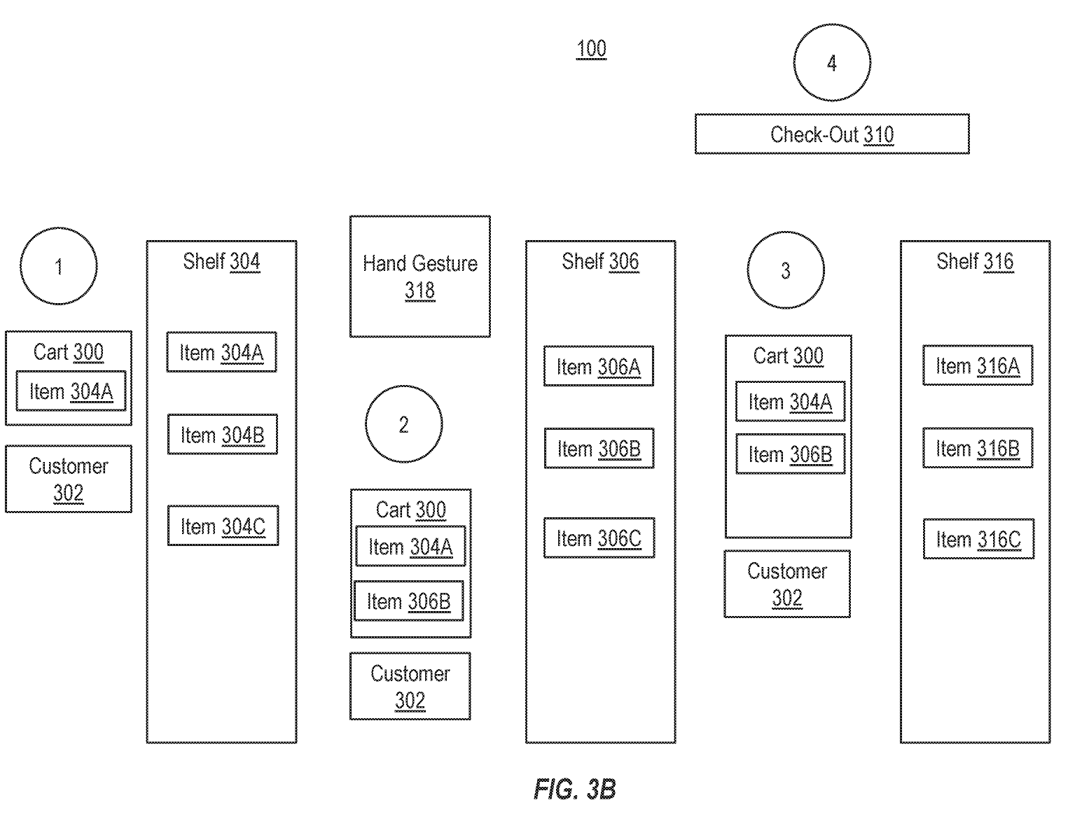

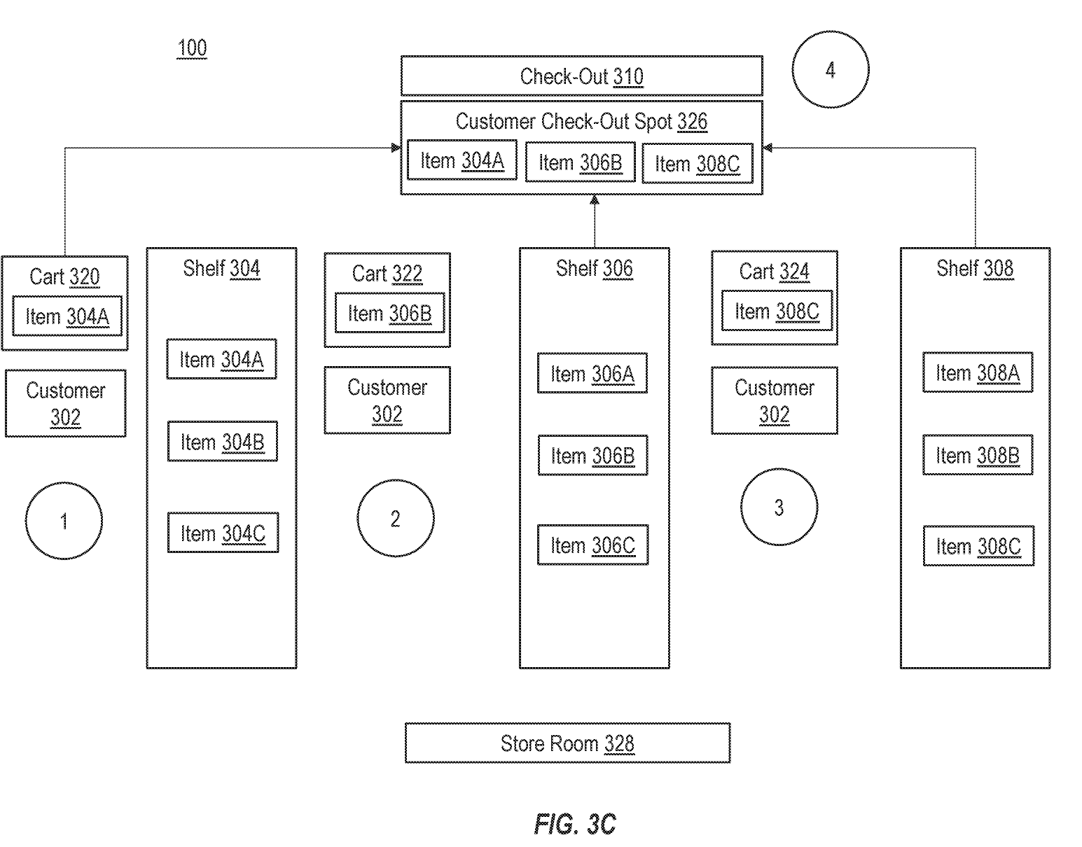

FIG. 3A illustrates an embodiment of the operation of a robot cart in the retail location 100. As illustrated in FIG. 3A , a robot cart 300, which corresponds to the robot cart 200, is programmed to have the functionality to assist customers 302, who corresponds to the customers 102, by providing information about item 105 locations, details, and recommendations, enhancing the overall shopping experience. When a customer 302 is looking for a specific item 105, but is not sure where it is, the customer 302 can enter the item’s name/category/brand information using the user input 218, and the screens 216 will identify the location of the item. In addition, the navigation system 220 can show a map to the customer 302 and can, in conjunction with the route planning models 236, move the robot cart 300 to the location of the specific item 105.

In some embodiments, the robot cart 300 is assigned to a customer 302 upon the customer 302 entering the retail location 100. For example, a previously described, the customer’s picture can be input into the customer database 222 and the cart can use the captured video frames 210 and the facial recognition models 232 to constantly look for the customer 302 shown in the picture and follow the customer. In other embodiments, the customer can be assigned a beacon as previously discussed. By utilizing the cameras 206, the sensors 208, and the various ML models, the robot cart 300 can follow the customer 302 as well as avoid collisions with other carts, humans, and the aisles.

In the embodiment of FIG. 3A, the retail location 100 includes shelves and items on the shelves that correspond to the shelves 104 and items 105. For example, a shelf 304 that includes items 304A, 304B, and 304C, a shelf 306 that includes items 306A, 306B, and 306C, and a shelf 308 that includes items 308A, 308B, and 308C. The retail location also includes a check-out area 310.

At a first time period 1, a customer 302 desires to purchase item 304A. Accordingly, the customer 302 walks to the location of the shelf 304 and the robot cart 300 follows the customer to that location. Alternatively, the cart 300 leads the customer 302 to the location of the shelf 304. At the location of the shelf 304, the customer 302 scans the item 304A with the UPC scanner 214 or shows the item to the cameras 206 for visual recognition and then places the item 304A into the robot cart 300. The robot cart 300 is able to deduct the item 304A from the current inventory and also adds the price of the item to a running total.

At a second time period 2, the customer 302 desires to purchase item 306B. Accordingly, the customer 302 walks to the location of the shelf 306 and the robot cart 300 follows the customer to that location. Alternatively, the cart 300 leads the customer 302 to the location of the shelf 306. At the location of the shelf 306, the customer 302 scans the item 306B with the UPC scanner 214 or shows the item to the cameras 206 for visual recognition of the item and then places the item 306B into the robot cart 300. The robot cart 300 is able to deduct the item 306B from the current inventory and also adds the price of the item to a running total.

At a third time period 3, the customer 302 desires to purchase item 308C. Accordingly, the customer 302 walks to the location of the shelf 308 and the robot cart 300 follows the customer to that location. Alternatively, the cart 300 leads the customer 302 to the location of the shelf 308. At the location of the shelf 308, the customer 302 scans the item 308C with the UPC scanner 214 or shows the item to the cameras 206 for visual recognition and then places the item 308C into the robot cart 300. The robot cart 300 is able to deduct the item 304A from the current inventory and also adds the price of the item to a running total.

At a time period 4, after the customer 302 has selected all their desired items, the customer 302 goes to the check-out area 310. As the robot cart has already tracked all the items placed in it and tallied the total cost, the customer 302 can quickly pay an employee 108 the purchase price. Alternatively, a credit card or other payment service can be automatically charged the purchase price so that the customer 302 can skip the check-out line.

At a time period 5, the customer 302 goes to their car 312 in the parking lot of the retail location 100. In the embodiment, the robot cart 300 follows the customer 302 to the car 312 so the customer does not have to carry the purchased items to the car. Once empty, the robot cart 300 will use the navigation system 220 and route planning models 236 to automatically return to the retail location 100.

FIG. 3B illustrates an alternative embodiment of the operation of a robot cart in the retail location 100 when a hand gesture is detected by the gesture detection models 230. In the embodiment of FIG. 3B, after time period 2 as the customer 302 and the robot cart 300 are moving toward the shelf 308, an items spills on the route being used by the customer 302 and the robot cart 300. Accordingly, an employee 108 provides a hand gesture 318 that directs the robot cart to take an alternative route. The hand gesture 318 is recognized by the gesture detection models 230 and the navigation system 220 and route planning models 236 plan an alternative route. Thus, at the time period 3 the customer 302 and robot cart 300 end up the location of a shelf 316 that has items 316A, 316B, and 316C, which can be purchased by the customer is desired.

FIG. 3C illustrates an alternative embodiment of the operation of a robot cart in the retail location 100. In the embodiment of FIG. 3C, the retail location 100 includes a robot cart 320 that is in the location of the shelf 304 having items 304A, 304B, and 304C, a robot cart 322 that is in the location of the shelf 306 having items 306A, 306B, and 306C, and a robot cart 324 that is in the location of the shelf 308 having items 308A, 308B, and 308C. Thus, in this embodiment the robot carts do not follow the customer 302 around the retail location 100. In some embodiments, the robot carts 320, 322, and 324 can be hung on a cableway in the air, thus saving on aisle space. It will be appreciated that the robot carts 320, 322, and 324 correspond to the robot cart 200.

In the embodiment, the customer 302 provides the user identification to the customer database 136 of the central computing system and then this is provided to the customer databases of each of the robot carts. This identification is used to track which items belong to which customer 102. Alternatively, the customer 302 can be given a beacon as previously described. In addition, each customer 302 is assigned a customer check-out spot 326 that is near to the check-out area 310.

At a first time period 1, a customer 302 desires to purchase item 304A. Accordingly, the customer 302 walks to the location of the shelf 304. At the location of the shelf 304, the customer 302 scans the item 304A with the UPC scanner 214 or shows the item to the cameras 206 for visual recognition and then places the item 304A into the robot cart 320. The robot cart 320 is able to deduct the item 304A from the current inventory and also adds the price of the item to a running total. Since the customer 302 is known by the robot cart 320, the robot cart is able to keep track of which items that are placed in it belong to the customer 302. Once the item 304A has been placed in the robot cart 320, or perhaps after a specified amount of time, the robot cart 320 automatically carries the item 304A to the customer check-out spot 326, which can be robot cart 300, a cube, a shelf, a basket, or the like, where the item 304A is stored until the customer 302 is ready to pay for the item.

At a second time period 2, the customer 302 desires to purchase item 306B. Accordingly, the customer 302 walks to the location of the shelf 306. At the location of the shelf 306, the customer 302 scans the item 306B with the UPC scanner 214 or shows the item to the cameras 206 for visual recognition and then places the item 306B into the robot cart 322. The robot cart 322 is able to deduct the item 306B from the current inventory and also adds the price of the item to a running total. Once the item 306B has been placed in the robot cart 322, or perhaps after a specified amount of time, the robot cart 322 automatically carries the item 306B to the customer check-out spot 326, where the item 306B is stored until the customer 302 is ready to pay for the item.

At a third time period 3, the customer 302 desires to purchase item 308C. Accordingly, the customer 302 walks to the location of the shelf 308. At the location of the shelf 308, the customer 302 scans the item 308C with the UPC scanner 214 or shows the item to the cameras 206 for visual recognition and then places the item 308C into the robot cart 324. The robot cart 324 is able to deduct the item 308C from the current inventory and also adds the price of the item to a running total. Once the item 308C has been placed in the robot cart 324, or perhaps after a specified amount of time, the robot cart 324 automatically carries the item 308C to the customer check-out spot 326, where the item 308C is stored until the customer 302 is ready to pay for the item.

In some embodiments, the customer 302 inputs a desired item into one of the robot carts 320, 322, or 324. The carts, especially if they are implemented using the cableway in the air, are then able to go to a store room 328 to retrieve the desired item and then take it to the customer check-out spot 326. Since the items selected by the customer 302 are only kept in the robot cart for a short period of time before being stored at the customer check-out spot 326, it does not matter if the item is selected from one of the shelves or from the store room 328. Thus, it is possible to only put out a small number of the items on the shelves for the customer to look out, but have the robot carts retrieve desired items from the store room 328, thus potentially saving on retail location 100 space.

At a time period 4, after the customer 302 has selected all their desired items, the customer 302 goes to the check-out area 310. As the robot carts has already tracked all the items placed in it and tallied the total cost, the customer 302 can quickly pay an employee 108 the purchase price. Alternatively, a credit card or other payment option can be charged the purchase price so that the customer 302 can skip the check-out line. The customer 302 can then collect the items stored in the customer check-out spot 326.

### Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

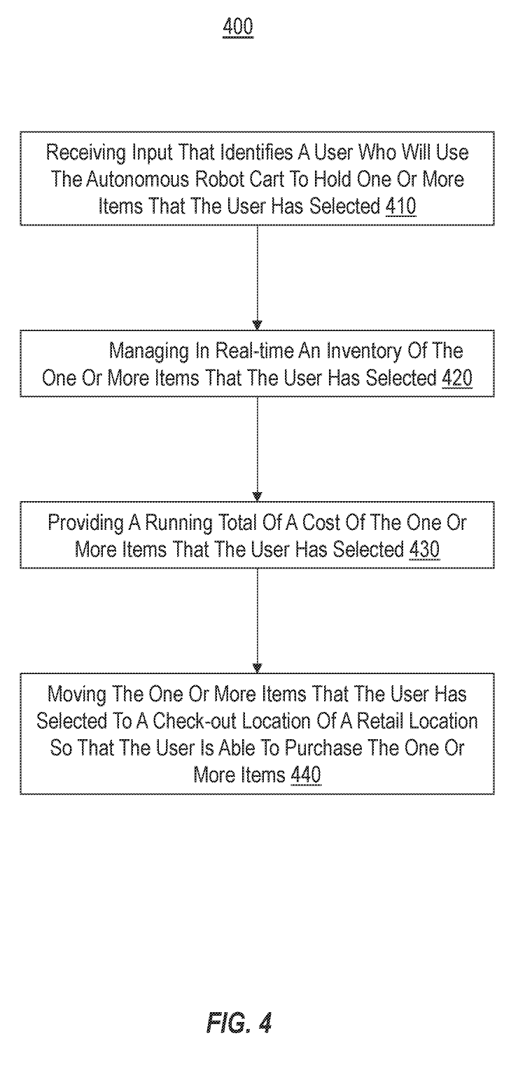

Directing attention now to FIG. 4, an example method 400 is disclosed. The method 400 will be described in relation to one or more of the figures previously described, although the method 400 is not limited to any particular embodiment.

The method 400 includes receiving input that identifies a user who will use the autonomous robot cart to hold one or more items that the user has selected (410). For example, as previously described the robot carts 200, 300, 320, 322, and/or 324 receive input that identifies the customer 102, 302 who will be using the robot cart. In some embodiments, the input is a picture from the customer that is used in conjunction with the ML facial recognition models 232. In other embodiments, signals are received from a beacon that has been assigned to the customer.

The method 400 includes managing in real-time an inventory of the one or more items that the user has selected (420). For example, as previously described the inventory database 226 and the ML selected items models 228 provide real-time inventory management.

The method 400 includes providing a running total of a cost of the one or more items that the user has selected (430). For example, as previously described the robot carts 200, 300, 320, 322, and/or 324 are able to keep a running total costs of the items 105 that the customer 102, 302 places in the robot carts. In some embodiments, this is done by the customer using the UPC scanner 214. In other embodiments, the cameras 206 are used for visual recognition of the price of the item.

The method 400 includes moving the one or more items that the user has selected to a check-out location of a retail location so that the user is able to purchase the one or more items (440). For example, as previously described the robot carts 200, 300, 320, 322, and/or 324 move the selected items 105 to the check-out area for purchase by the customer. This can be done according to the embodiments discussed in FIGS. 3A and 3C.

### Further Example Embodiments

Following are some further example embodiments of the invention. These are presented only by way of example and are not intended to limit the scope of the invention in any way.

Embodiment 1. A method for operating an autonomous robot cart in a retail location, the method including: receiving input that identifies a user who will use the autonomous robot cart to hold one or more items that the user has selected; managing in real-time an inventory of the one or more items that the user has selected; providing a running total of a cost of the one or more items that the user has selected; and moving the one or more items that the user has selected to a check-out location of a retail location so that the user is able to purchase the one or more items.

Embodiment 2. The method as recited in embodiment 1, wherein receiving the input that identifies the user comprises: receiving a picture from the user; collecting video frames using a camera that is included in the autonomous robot; and performing facial recognition using a facial recognition machine-learning (ML) model.

Embodiment 3. The method as recited in any of embodiments 1-2, wherein receiving the input that identifies the user comprises: receiving signals from a beacon that has been assigned to the user.

Embodiment 4. The method as recited in any of embodiments 1-3, wherein moving the one or more items that the user has selected to the check-out location comprises: assigning the autonomous robot cart to the user based on the received input that identifies the user; causing the assigned autonomous robot cart to follow the user to a first location where a first one of the one or more items is located so that the user can select the first one of the one or more items and place the first one of the one or more items in the autonomous robot cart; causing the assigned autonomous robot cart to follow the user to a second location where a second one of the one or more items is located so that the user can select the second one of the one or more items and place the second one of the one or more items in the autonomous robot cart; and causing the assigned autonomous robot cart that holds the first and second ones of the one or more items to follow the user to the check-out location.

Embodiment 5. The method as recited in any of embodiments 1-4, further comprising: causing the assigned autonomous robot cart that holds the first and second ones of the one or more items to follow the user to a vehicle of the user that is located outside the retail location after the first and second ones of the one or more items have been purchased; and causing the assigned autonomous robot cart to automatically return to the retail location.

Embodiment 6. The method as recited in any of embodiments 1-5, further comprising: causing the autonomous robot cart to follow the user to a first location where a first one of the one or more items is located so that the user can select the first one of the one or more items and place the first one of the one or more items in the autonomous robot cart; identifying by use of a ML gesture detection model a hand gesture received from the user or from an employee of the retail location; and causing the autonomous robot cart to deviate from a planned route based on the received hand gesture.

Embodiment 7. The method as recited in any of embodiments 1-6, wherein moving the one or more items that the user has selected to the check-out location comprises: assigning the autonomous robot cart to a specific area of the retail location; receiving the one or more items that the user has selected; identifying that the received one or more items are associated with the user based on the received input that identifies the user; moving the received one or more items to a user assigned storage area at the check-out location for storage until the user purchases the one or more items; and causing the autonomous robot cart to automatically return to the specific location once the one or more items have been moved to the assigned storage area.

Embodiment 8. The method as recited in any of embodiments 1-7, wherein moving the one or more items that the user has selected to the check-out location comprises: assigning the autonomous robot cart to a specific area of the retail location; receiving input from the user that identifies the one or more items that the user has selected; causing the autonomous robot to retrieve the one or more items that the user has selected from a store room of the retail location; moving the received one or more items to a user assigned storage area at the check-out location for storage until the user purchases the one or more items; and causing the autonomous robot cart to automatically return to the specific location once the one or more items have been moved to the assigned storage area.

Embodiment 9. The method as recited in any of embodiments 1-8, further comprising: automatically charging a payment service of the user the running total of the cost of the one or more items that the user has selected when the autonomous robot cart moves the one or more items that the user has selected to the check-out location.

Embodiment 10. The method as recited in any of embodiments 1-9, further comprising: providing location information about the one or more items in the retail location to the user.

Embodiment 11. A computing system for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-11.

### Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

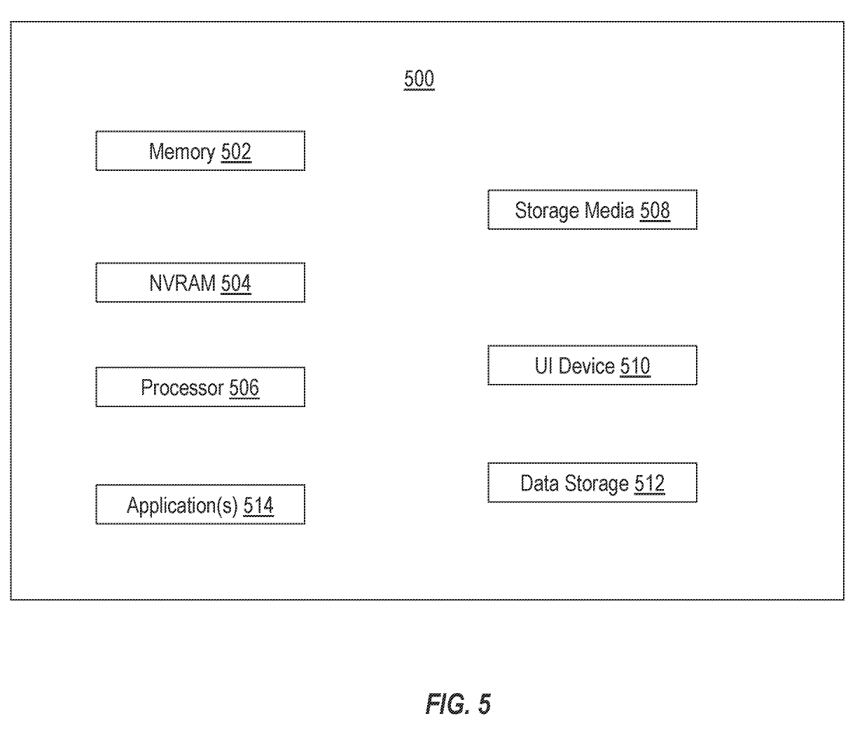

With reference briefly now to FIG. 5, any one or more of the entities disclosed, or implied, by FIGS. 1-4 and/or elsewhere herein, may take the form of, or include, or be implemented on, or hosted by, a physical computing device, one example of which is denoted at 800. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 504 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An autonomous robot cart comprising:
one or more processors; and
one or more non-transitory computer-readable hardware storage devices having stored thereon computer-executable instructions that are structured such that, when executed by the one or more processors, the computer-executable instructions cause the autonomous robot cart to perform at least:
receive input that identifies a user who will use the autonomous robot cart to hold one or more items that the user has selected;
manage in real-time an inventory of the one or more items that the user has selected;
provide a running total of a cost of the one or more items that the user has selected; and
move the one or more items that the user has selected to a check-out location of a retail location so that the user is able to purchase the one or more items.

2. The autonomous robot cart of claim 1, wherein receiving the input that identifies the user comprises:
receiving a picture from the user;
collecting video frames using a camera that is included in the autonomous robot; and
performing facial recognition using a facial recognition machine-learning (ML) model.

3. The autonomous robot cart of claim 1, wherein receiving the input that identifies the user comprises:
receiving signals from a beacon that has been assigned to the user.

4. The autonomous robot cart of claim 1, wherein moving the one or more items that the user has selected to the check-out location comprises:
assigning the autonomous robot cart to the user based on the received input that identifies the user;
causing the assigned autonomous robot cart to follow the user to a first location where a first one of the one or more items is located so that the user can select the first one of the one or more items and place the first one of the one or more items in the autonomous robot cart;
causing the assigned autonomous robot cart to follow the user to a second location where a second one of the one or more items is located so that the user can select the second one of the one or more items and place the second one of the one or more items in the autonomous robot cart; and
causing the assigned autonomous robot cart that holds the first and second ones of the one or more items to follow the user to the check-out location.

5. The autonomous robot cart of claim 4, wherein computer-executable instructions, when executed, further cause the autonomous robot cart to perform at least:
causing the assigned autonomous robot cart that holds the first and second ones of the one or more items to follow the user to a vehicle of the user that is located outside the retail location after the first and second ones of the one or more items have been purchased; and
causing the assigned autonomous robot cart to automatically return to the retail location.

6. The autonomous robot cart of claim 1, wherein the computer-executable instructions, when executed, further cause the autonomous robot cart to perform at least:
follow the user to a first location where a first one of the one or more items is located so that the user can select the first one of the one or more items and place the first one of the one or more items in the autonomous robot cart;
identifying by use of a ML gesture detection model a hand gesture received from the user or from an employee of the retail location; and
causing the autonomous robot cart to deviate from a planned route based on the received hand gesture.

7. The autonomous robot cart of claim 1, wherein moving the one or more items that the user has selected to the check-out location comprises:
assigning the autonomous robot cart to a specific area of the retail location;
receiving the one or more items that the user has selected;
identifying that the received one or more items are associated with the user based on the received input that identifies the user;
moving the received one or more items to a user assigned storage area at the check-out location for storage until the user purchases the one or more items; and
causing the autonomous robot cart to automatically return to the specific location once the one or more items have been moved to the assigned storage area.

8. The autonomous robot cart of claim 1, wherein moving the one or more items that the user has selected to the check-out location comprises:
assigning the autonomous robot cart to a specific area of the retail location;
receiving input from the user that identifies the one or more items that the user has selected;
causing the autonomous robot to retrieve the one or more items that the user has selected from a store room of the retail location;
moving the received one or more items to a user assigned storage area at the check-out location for storage until the user purchases the one or more items; and
causing the autonomous robot cart to automatically return to the specific location once the one or more items have been moved to the assigned storage area.

9. The autonomous robot cart of claim 1, wherein the computer-executable instructions, when executed, further cause the autonomous robot cart to perform at least:
automatically charge a payment service of the user the running total of the cost of the one or more items that the user has selected when the autonomous robot cart moves the one or more items that the user has selected to the check-out location.

10. The autonomous robot cart of claim 1, wherein the computer-executable instructions, when executed, further cause the autonomous robot cart to perform at least:
provide location information about the one or more items in the retail location to the user.

11. A method for operating an autonomous robot cart in a retail location, the method comprising:
receiving input that identifies a user who will use the autonomous robot cart to hold one or more items that the user has selected;
managing in real-time an inventory of the one or more items that the user has selected;
providing a running total of a cost of the one or more items that the user has selected; and
moving the one or more items that the user has selected to a check-out location of a retail location so that the user is able to purchase the one or more items.

12. The method of claim 11, wherein receiving the input that identifies the user comprises:
receiving a picture from the user;
collecting video frames using a camera that is included in the autonomous robot; and
performing facial recognition using a facial recognition machine-learning (ML) model.

13. The method of claim 11, wherein receiving the input that identifies the user comprises:
receiving signals from a beacon that has been assigned to the user.

14. The method of claim 11, wherein moving the one or more items that the user has selected to the check-out location comprises:
assigning the autonomous robot cart to the user based on the received input that identifies the user;
causing the assigned autonomous robot cart to follow the user to a first location where a first one of the one or more items is located so that the user can select the first one of the one or more items and place the first one of the one or more items in the autonomous robot cart;
causing the assigned autonomous robot cart to follow the user to a second location where a second one of the one or more items is located so that the user can select the second one of the one or more items and place the second one of the one or more items in the autonomous robot cart; and
causing the assigned autonomous robot cart that holds the first and second ones of the one or more items to follow the user to the check-out location.

15. The method of claim 14, further comprising:
causing the assigned autonomous robot cart that holds the first and second ones of the one or more items to follow the user to a vehicle of the user that is located outside the retail location after the first and second ones of the one or more items have been purchased; and
causing the assigned autonomous robot cart to automatically return to the retail location.

16. The method of claim 11, further comprising:
causing the autonomous robot cart to follow the user to a first location where a first one of the one or more items is located so that the user can select the first one of the one or more items and place the first one of the one or more items in the autonomous robot cart;
identifying by use of a ML gesture detection model a hand gesture received from the user or from an employee of the retail location; and
causing the autonomous robot cart to deviate from a planned route based on the received hand gesture.

17. The method of claim 11, wherein moving the one or more items that the user has selected to the check-out location comprises:
assigning the autonomous robot cart to a specific area of the retail location;
receiving the one or more items that the user has selected;
identifying that the received one or more items are associated with the user based on the received input that identifies the user;
moving the received one or more items to a user assigned storage area at the check-out location for storage until the user purchases the one or more items; and
causing the autonomous robot cart to automatically return to the specific location once the one or more items have been moved to the assigned storage area.

18. The method of claim 11, wherein moving the one or more items that the user has selected to the check-out location comprises:
assigning the autonomous robot cart to a specific area of the retail location;
receiving input from the user that identifies the one or more items that the user has selected;
causing the autonomous robot to retrieve the one or more items that the user has selected from a store room of the retail location;
moving the received one or more items to a user assigned storage area at the check-out location for storage until the user purchases the one or more items; and
causing the autonomous robot cart to automatically return to the specific location once the one or more items have been moved to the assigned storage area.

19. The method of claim 11, further comprising:
automatically charging a payment service of the user the running total of the cost of the one or more items that the user has selected when the autonomous robot cart moves the one or more items that the user has selected to the check-out location.

20. The method of claim 11, further comprising:
providing location information about the one or more items in the retail location to the user.
